(19) United States
(12) Patent Application Publication
(10) Pub. No.: US 2015/0181565 A1
(43) Pub. Date: Jun. 25, 2015

(54) APPARATUS, SYSTEM AND METHOD OF TRIGGERING A WIRELESS-LOCAL-AREA-NETWORK (WLAN) ACTION OF A USER EQUIPMENT (UE)

(71) Applicants: Alexander Sirotkin, Giv'on Hachadasha (IL); Pingping Zong, Randolph, NJ (US)

(72) Inventors: Alexander Sirotkin, Giv'on Hachadasha (IL); Pingping Zong, Randolph, NJ (US)

(21) Appl. No.: 14/129,288

(22) PCT Filed: Sep. 10, 2013
(86) PCT No.: PCT/US2013/058987

§ 371 Date: Dec. 25, 2013

Related U.S. Application Data
(60) Provisional application No. 61/748,706, filed on Jan. 3, 2013.

(51) Int. Cl. H04W 72/04; H04W 48/16; H04W 76/02; H04W 52/02

(52) U.S. Cl. CPC H04W 72/042; H04W 52/0222; H04W 48/16; H04W 76/02

(57) ABSTRACT

Some demonstrative embodiments include devices, systems and/or methods of triggering a Wireless Local Area Network (WLAN) action of a wireless communication device, e.g., a User Equipment (UE). For example, an Evolved Node B (eNB) may include a radio to transmit a control message to a UE, the control message including a WLAN trigger to trigger one or more actions by a WLAN transceiver of the UE.

### CROSS REFERENCE

This application claims the benefit of and priority from U.S. Provisional Patent Application No. 61/748,706 entitled “Advanced Wireless Communication Systems and Techniques”, filed Jan. 3, 2013, the entire disclosure of which is incorporated herein by reference.

### TECHNICAL FIELD

Some embodiments described herein generally relate to apparatus, system and method of triggering a Wireless Local Area Network (WLAN) action by a wireless communication device.

### BACKGROUND

A wireless communication device, e.g., a mobile device, may be configured to utilize multiple wireless communication technologies.

For example, a User Equipment (UE) device may be configured to utilize a cellular connection, e.g., a Long Term Evolution (LTE) cellular connection, as well as a wireless-local-area-network (WLAN) connection, e.g., a Wireless-Fidelity (WiFi) connection.

The UE may be configured to enable a user of the UE to disable (“turn off”) a functionality of a WLAN transceiver of the UE, e.g., in order to conserve a battery and/or to disable receipt of prompt messages prompting the user to connect to WLAN-based services.

However, the UE may not be able to connect to a WLAN when the WLAN functionality is disabled.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic flow-chart illustration of a method of triggering a Wireless Local Area Network (WLAN) action of a wireless communication device, in accordance with some demonstrative embodiments.

FIG. 3 is a schematic illustration of a product, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a Personal Computer (PC), a desktop computer, a mobile computer, a laptop computer, a notebook computer, a tablet computer, a Smartphone device, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a cellular network, a cellular node, a Wireless Local Area Network (WLAN), a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, vending machines, sell terminals, and the like.

Some embodiments may be used in conjunction with devices and/or networks operating in accordance with existing Long Term Evolution (LTE) specifications (including “RAN2 RRC—3GPP TS 36.331: Evolved Universal Terrestrial Radio Access (E-UTRA); Radio Resource Control (RRC); Protocol specification”; and “36.300 —Evolved Universal Terrestrial Radio Access (E-UTRA) and Evolved Universal Terrestrial Radio Access Network (E-UTRAN); Overall description; Stage 2”) and/or future versions and/or derivatives thereof, devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012), and/or future versions and/or derivatives thereof, devices and/or networks operating in accordance with existing IEEE 802.16 standards (IEEE-Std 802.16, 2009 Edition, Air Interface for Fixed Broadband Wireless Access Systems; IEEE-Std 802.16e, 2005 Edition, Physical and Medium Access Control Layers for Combined Fixed and Mobile Operation in Licensed Bands; amendment to IEEE Std 802.16-2009, developed by Task Group m) and/or future versions and/or derivatives thereof, devices and/or networks operating in accordance with existing WirelessHD™specifications and/or future versions and/or derivatives thereof, units and/or devices which are part of the above networks, and the like.

Some embodiments may be used in conjunction with one or more types of wireless communication signals and/or systems, for example, Radio Frequency (RF), Frequency-Division Multiplexing (FDM), Orthogonal FDM (OFDM), Single Carrier Frequency Division Multiple Access (SC-FDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wireless Fidelity (Wi-Fi), Wi-Max, ZigBee™, Ultra-Wideband (UWB), Global System for Mobile communication (GSM), second generation (2G), 2.5G, 3G, 3.5G, 4G, Fifth Generation (5G) mobile networks, 3GPP, Long Term Evolution (LTE) cellular system, LTE advance cellular system, High-Speed Downlink Packet Access (HSDPA), High-Speed Uplink Packet Access (HSUPA), High-Speed Packet Access (HSPA), HSPA+, Single Carrier Radio Transmission Technology (1XRTT), Evolution-Data Optimized (EV-DO), Enhanced Data rates for GSM Evolution (EDGE), and the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

Some demonstrative embodiments are described herein with respect to a LTE cellular system. However, other embodiments may be implemented in any other suitable cellular network, e.g., a 3G cellular network, a 4G cellular network, a 5G cellular network, a WiMax cellular network, and the like.

Some demonstrative embodiments are described herein with respect to a WLAN system. However, other embodiments may be implemented in any other suitable non-cellular network.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a dipole antenna, a set of switched beam antennas, and/or the like.

The term “cell”, as used herein, may include a combination of network resources, for example, downlink and optionally uplink resources. The resources may be controlled and/or allocated, for example, by a cellular node (also referred to as a “base station”), or the like. The linking between a carrier frequency of the downlink resources and a carrier frequency of the uplink resources may be indicated in system information transmitted on the downlink resources.

The phrase “access point” (AP), as used herein, may include an entity that includes a station (STA) and provides access to distribution services, via the Wireless Medium (WM) for associated STAs. A WiFi Access Controller (AC) may be deployed to control a plurality of APs, e.g., lightweight APs.

The term “station” (STA), as used herein, may include any logical entity that is a singly addressable instance of a medium access control (MAC) and a physical layer (PHY) interface to the WM.

The phrases “directional multi-gigabit (DMG)” and “directional band” (DBand), as used herein, may relate to a frequency band wherein the Channel starting frequency is above 56 GHz.

The phrases “DMG STA” and “mmWave STA (mSTA)” may relate to a STA having a radio transmitter, which is operating on a channel that is within the DMG band.

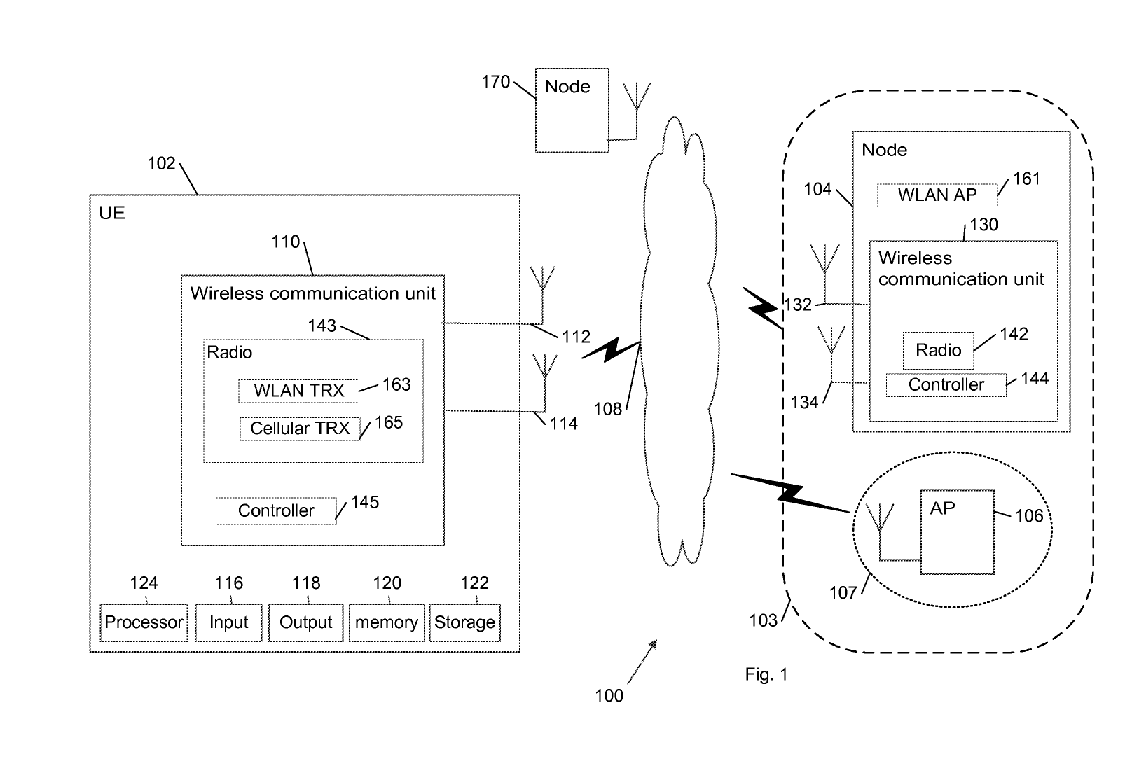

Reference is now made to FIG. 1, which schematically illustrates a block diagram of a system 100, in accordance with some demonstrative embodiments.

As shown in FIG. 1, in some demonstrative embodiments, system 100 may include one or more wireless communication devices capable of communicating content, data, information and/or signals via one or more wireless mediums 108. For example, system 100 may include at least one User Equipment (UE) 102 capable of communicating with one or more wireless communication networks, e.g., as described below.

Wireless mediums 108 may include, for example, a radio channel, a cellular channel, an RF channel, a WLAN channel, a Wireless Fidelity (WiFi) channel, an IR channel, and the like. One or more elements of system 100 may optionally be capable of communicating over any suitable wired communication links.

In some demonstrative embodiments, system 100 may include at least one cellular network 103, e.g., a cell controlled by a node 104.

In some demonstrative embodiments, system 100 may include at least one non-cellular network 107, for example, a WLAN, e.g., a Basic Service Set (BSS), managed by an Access Point (AP) 106.

In some demonstrative embodiments, non-cellular network 107 may at least partially be within a coverage area of node 104. For example, AP 106 may be within a coverage area of node 104.

In some demonstrative embodiments, node 104 may include an Evolved Node B (eNB). For example, node 104 may be configured to perform radio resource management (RRM), radio bearer control, radio admission control (access control), connection mobility management, resource scheduling between UEs and eNB radios, e.g., Dynamic allocation of resources to UEs in both uplink and downlink, header compression, link encryption of user data streams, packet routing of user data towards a destination, e.g., another eNB or an Evolved Packet Core (EPC), scheduling and/or transmitting paging messages, e.g., incoming calls and/or connection requests, broadcast information coordination, measurement reporting, and/or any other operations.

In other embodiments, node 104 may include any other functionality and/or may perform the functionality of any other cellular node, e.g., a Node B (NB) or any other node or device.

In some demonstrative embodiments, UE 102 may include, for example, a mobile computer, a laptop computer, a notebook computer, a tablet computer, a mobile internet device, a handheld computer, a handheld device, a storage device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a mobile phone, a cellular telephone, a PCS device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a video device, an audio device, an A/V device, a gaming device, a media player, a Smartphone, or the like.

In some demonstrative embodiments, UE 102, node 104 and/or AP 106 may include one or more wireless communication units to perform wireless communication between UE 102, node 104, AP 106 and/or with one or more other wireless communication devices, e.g., as described below. For example, UE 102 may include a wireless communication unit 110 and/or node 104 may include a wireless communication unit 130.

In some demonstrative embodiments, wireless communication units 110 and 130 may include, or may be associated with, one or more antennas. In one example, wireless communication unit 110 may be associated with at least two antennas, e.g., antennas 112 and 114; and/or wireless communication unit 130 may be associated with at least two antennas, e.g., antennas 132 and 134.

In some demonstrative embodiments, antennas 112, 114, 132 and/or 134 may include any type of antennas suitable for transmitting and/or receiving wireless communication signals, blocks, frames, transmission streams, packets, messages and/or data. For example, antennas 112, 114,132 and/or 134 may include any suitable configuration, structure and/or arrangement of one or more antenna elements, components, units, assemblies and/or arrays. For example, antennas 112, 114, 132 and/or 134 may include a phased array antenna, a dipole antenna, a single element antenna, a set of switched beam antennas, and/or the like.

In some embodiments, antennas 112, 114, 132 and/or 134 may implement transmit and receive functionalities using separate transmit and receive antenna elements. In some embodiments, antennas 112, 114, 132 and/or 134 may implement transmit and receive functionalities using common and/or integrated transmit/receive elements.

In some demonstrative embodiments, wireless communication unit 130 may include one or more radios 142 and at least one controller 144 to control communications performed by on or more radios 142, and/or wireless communication unit 110 may include one or more radios 143 and at least one controller 145 to control communications performed by one or more radios 143. For example, radios 142 and/or 143 may include one or more wireless transmitters, receivers and/or transceivers able to send and/or receive wireless communication signals, RF signals, frames, blocks, transmission streams, packets, messages, data items, and/or data.

In some demonstrative embodiments, one or more radio 143 may include a WLAN transceiver (TRX) 163 to communicate with AP 106 over a WLAN link, and a cellular transceiver 165 to communicate with node 104 over a cellular link.

In some demonstrative embodiments, the WLAN link may include, for example, a Wireless Fidelity (WiFi) link, a Wireless Gigabit (WiGig) link, or any other link.

In some demonstrative embodiments, the WLAN link may include, for example, a link over the 2.4 Gigahertz (GHz) or 5 GHz frequency band, the 60 GHz frequency band, or any other frequency band.

In some demonstrative embodiments, radios 142 and/or 143 may include a multiple input multiple output (MIMO) transmitters receivers system (not shown), which may be capable of performing antenna beamforming methods, if desired.

In some demonstrative embodiments, radios 142 and/or 143 may include a turbo decoder and/or a turbo encoder (not shown) for encoding and/or decoding data bits into data symbols, if desired.

In some demonstrative embodiments, radios 142 and/or 143 may include OFDM and/or SC-FDMA modulators and/or demodulators (not shown) configured to communicate OFDM signals over downlink channels, e.g., between node 104 and UE 102, and SC-FDMA signals over uplink channels, e.g., between UE 102 and node 104.

In some demonstrative embodiments, wireless communication unit 110 may establish a WLAN link with AP 106. For example, wireless communication unit 110 may perform the functionality of one or more STAs, e.g., one or more WiFi STAs, WLAN STAs, and/or DMG STAs. The WLAN link may include an uplink and/or a downlink. The WLAN downlink may include, for example, a unidirectional link from AP 106 to the one or more STAs or a unidirectional link from a Destination STA to a Source STA. The uplink may include, for example, a unidirectional link from a STA to AP 106 or a unidirectional link from the Source STA to the Destination STA.

In some demonstrative embodiments, UE 102, node 104 and/or AP 106 may also include, for example, one or more of a processor 124, an input unit 116, an output unit 118, a memory unit 120, and a storage unit 122. UE 102, node 104 and/or AP 106 may optionally include other suitable hardware components and/or software components. In some demonstrative embodiments, some or all of the components of one or more of UE 102, node 104 and/or AP 106 may be enclosed in a common housing or packaging, and may be interconnected or operably associated using one or more wired or wireless links. In other embodiments, components of one or more of UE 102, node 104 and/or AP 106 may be distributed among multiple or separate devices.

Processor 124 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 124 executes instructions, for example, of an Operating System (OS) of UE 102, node 104 and/or AP 106 and/or of one or more suitable applications.

Input unit 116 includes, for example, a keyboard, a keypad, a mouse, a touch-screen, a touch-pad, a track-ball, a stylus, a microphone, or other suitable pointing device or input device. Output unit 118 includes, for example, a monitor, a screen, a touch-screen, a flat panel display, a Cathode Ray Tube (CRT) display unit, a Liquid Crystal Display (LCD) display unit, a plasma display unit, one or more audio speakers or earphones, or other suitable output devices.

Memory unit 120 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 122 includes, for example, a hard disk drive, a floppy disk drive, a Compact Disk (CD) drive, a CD-ROM drive, a DVD drive, or other suitable removable or non-removable storage units. Memory unit 120 and/or storage unit 122, for example, may store data processed by UE 102, node 104 and/or AP 106.

In some demonstrative embodiments, UE 102 may be configured to utilize a cellular connection, e.g., a Long Term Evolution (LTE) cellular connection, to communicate with node 104, and a WLAN connection, e.g., a Wireless-Fidelity (WiFi) connection, to communicate with AP 106.

In some demonstrative embodiments, UE 102 may be configured to enable a user of UE 102 to disable (“turn off”) a functionality of WLAN transceiver 163, e.g., in order to conserve a battery and/or to disable receipt of prompt messages prompting the user to connect to WLAN-based services.

In some demonstrative embodiments, UE 102 and/or node 104 may be configured to enable node 104 to trigger one or more actions of WLAN transceiver 163, e.g., as described in detail below.

In some demonstrative embodiments, node 104 may be configured to trigger one or more actions of WLAN transceiver 163, for example, regardless of and/or independent of a setting and/or mode of operation of WLAN transceiver 163.

In one example, node 104 may be configured to trigger one or more actions of WLAN transceiver 163, for example, even if the functionality of WLAN transceiver 163 is partially or fully disabled, e.g., by the user of UE 102.

In some demonstrative embodiments, enabling node 104 to trigger one or more actions of WLAN transceiver 163 may enable making and/or controlling mobility decisions with respect to UE 102 at node 104 and/or at any other element of system 100, for example, another cellular network element, e.g., another cellular node, a cellular core network (CN) element, and the like; a WLAN element, e.g., an AP, and/or any other local or remote device.

In some demonstrative embodiments, UE 102 may be configured to be responsible for making WLAN mobility decisions, e.g., with respect to switching to or from one or more WLANs.

In some demonstrative embodiments, node 104 may be configured to trigger one or more actions of UE 102, which may be related to WLAN mobility. Additionally or alternatively, node 104 may be able to trigger one or more other WLAN actions of UE 102.

In some demonstrative embodiments, radio 142 may transmit to UE 102 at least one WLAN trigger to trigger one or more actions by WLAN transceiver 163, e.g., as described below.

In some demonstrative embodiments, radio 142 may transmit the WLAN trigger as part of a control message, e.g., as described below.

In some demonstrative embodiments, radio 142 may transmit the WLAN trigger as part of an Information Element (IE), e.g., as described below.

In some demonstrative embodiments, cellular transceiver 165 may receive the WLAN trigger from node 104.

In some demonstrative embodiments, controller 145 may control WLAN transceiver 163 to perform the one or more WLAN actions based on the WLAN trigger, e.g., as described below.

In some demonstrative embodiments, the WLAN trigger may include a WLAN wakeup trigger to trigger activation of WLAN transceiver 163, e.g., as described below.

In some demonstrative embodiments, the WLAN wakeup trigger may be configured to trigger switching of WLAN transceiver 163 to an active mode of operation.

For example, the WLAN wakeup trigger may trigger switching of WLAN transceiver 163 to the active mode, when WLAN transceiver 163 is turned off or the functionality of WLAN transceiver 163 is partially or fully disabled, e.g., by the user of UE 102 or by an application executed by UE 102.

In some demonstrative embodiments, controller 145 may activate WLAN transceiver 163 based on the WLAN wakeup trigger received from node 104.

In one example, the functionality of WLAN transceiver 163 may be disabled, directly or indirectly, for example, by switching UE 102 to a predefined mode of operation, for example, an “airplane” mode, a power-save mode, a “WLAN off” mode, or the like.

In some demonstrative embodiments, node 104 may determine that UE 102 is within coverage of a WLAN, e.g., while UE 102 is not connected to the WLAN.

In some demonstrative embodiments, node 104 may include a WLAN AP 161 and may be configured to manage an AP, e.g., in addition to the cell 103 managed by node 104. In one example, node 104 may perform the functionality of a Smart Femto-cell Controller (SFC-C) having an integrated WLAN AP 161. In one example, WLAN AP 161 may be implemented as part of wireless communication unit 130. In another example, WLAN AP 161 and wireless communication unit 104 may be implemented as separate elements or units of node 104.

According to these embodiments, node 104 may be connected to UE 102 over the cellular link, e.g., even while the functionality of WLAN transceiver 163 of UE 102 may be partially or fully disabled.

According to these embodiments, node 104 may trigger UE 102 to activate WLAN transceiver 163, for example, when UE 102 moves into a coverage area of WLAN AP 161 and/or AP 106.

In one example, UE 102 may be connected via a cellular link to another cellular node 170, for example, while WLAN transceiver 163 of UE 102 may be turned off. For example, UE 102 may communicate both voice and data communications via the cellular link with node 170.

According to this example, UE 102 may be moved into range of node 104 and may switch to communicate with node 104 via a cellular link.

According to this example, node 104 may trigger UE 102 to activate WLAN transceiver 163 to communicate via a WLAN link with WLAN AP 161 or AP 106.

For example, triggering the activation of WLAN transceiver 163 may enable UE 102 to communicate with node 104 via the WLAN link, e.g., in addition to or instead of the cellular link between UE 102 and node 104.

For example, UE 102 may communicate one type of communications, for example, communications requiring a first bandwidth and/or rate, e.g., voice communications, via the cellular link with node 104, and UE 102 may communicate another type of communications, for example, communications requiring a second bandwidth and/or rate, e.g., data communications, via the WLAN link with WLAN AP 161.

In other embodiments, node 104 may not include WLAN AP 161.

In some demonstrative embodiments, node 104 may trigger UE 102 to activate WLAN transceiver 163 to connect to a WLAN AP external to node 104, e.g., AP 106.

In one example, node 104 may trigger UE 102 to activate WLAN transceiver 163, e.g., when UE 102 moves into a coverage area of WLAN AP 106.

For example, node 104 may determine a location of UE 102, and determine that UE 102 moves into a coverage area of WLAN AP 106 based on the location of UE 102, e.g., relative to a location of AP 106 and/or a coverage area of WLAN 107.

In some demonstrative embodiments, radio 142 may transmit to UE 102 a WLAN mobility trigger to trigger WLAN transceiver 163 to attempt to connect to a WLAN, e.g., as described below.

In some demonstrative embodiments, the WLAN mobility trigger may be configured to trigger WLAN transceiver 163 to perform WLAN association, WLAN scanning, WLAN access network discovery, e.g., via an Access Network Discovery and Selection Function (ANDSF), and/or any other WLAN action.

In some demonstrative embodiments, controller 145 may control WLAN transceiver 163 to attempt to connect to the WLAN, based on the WLAN mobility trigger received from node 104.

In one example, node 104 may transmit the WLAN mobility trigger to UE 102, for example, when UE 102 moves into a coverage area of WLAN AP 161, e.g., while UE is not connected to WLAN AP 161. According to this example, controller 145 may control WLAN transceiver 163 to connect to WLAN AP 161.

In another example, node 104 may transmit the WLAN mobility trigger to UE 102, for example, when UE 102 moves into a coverage area of WLAN 107, e.g., while UE is not connected to AP 106. According to this example, controller 145 may control WLAN transceiver 163 to connect to AP 106.

In some demonstrative embodiments, node 104 may transmit the WLAN mobility trigger to UE 102, for example, based on a location of UE 102 relative to a coverage area of WLAN 107. For example, node 104 determine a location of UE 102, and determine that UE 102 moves into a coverage area of AP 106 based on the location of UE 102, e.g., relative to a location of AP 106 and/or a coverage area of WLAN 107.

Although some demonstrative embodiments are described above with respect to some types of WLAN triggers, for example, the WLAN wakeup trigger and the WLAN mobility trigger, other embodiments may include any other type of WLAN trigger, which may be configured to trigger WLAN transceiver 163 to perform any other action.

In some demonstrative embodiments, node 104 may transmit the one or more WLAN triggers to UE 102 as part of at least one Radio-Resource-Control (RRC) signaling message.

In some demonstrative embodiments, node 104 may transmit the one or more WLAN triggers to UE 102 as part of at least one System Information Block (SIB), e.g., as described below.

In some demonstrative embodiments, node 104 may transmit the one or more WLAN triggers to UE 102 as part of a dedicated IE (“WLAN trigger IE”).

For example, the WLAN trigger IE may have the following format:

| | |
|---|---|
| -- ASN1START | |
| WLAN-Trigger ::= | CHOICE { |
| wlan-wake-up | OCTET STRING(1), |
| wlan-mobility | OCTET STRING(32), |
| ... | |
| } | |
| ASN1STOP | |

In one example, node 104 may transmit the WLAN trigger IE as part of a “MobilityFromEUTRACommand” message addressed to UE 102.

For example, the “MobilityFromEUTRACommand” message may be used to command handover or a cell change from Evolved Universal Terrestrial Radio Access (E-UTRA) to another Radio-Access-Technology (RAT), e.g., 3GPP or non-3GPP, or enhanced Circuit Switched (CS) fallback to CDMA2000 1xRTT. The “MobilityFromEUTRACommand” message may have the following attributes:

Signaling Radio Bearer (SRB): SRB1;

Radio Link Control (RLC) Service Access Point (SAP) (RLC-SAP): AM

Logical channel: Dedicated Control Channel (DCCH);

Direction: E-UTRAN to UE

In one example, the “MobilityFromEUTRACommand” message may include the WLAN trigger, e.g., as follows:

MobilityFromEUTRACommand message

| | |
|---|---|
| -- ASN1START | |
| MobilityFromEUTRACommand ::= | SEQUENCE { |

| | |
|---|---|
| rrc-TransactionIdentifier | RRC-TransactionIdentifier, |
| criticalExtensions | CHOICE { |
| c1 | CHOICE{ |

| | |
|---|---|
| mobilityFromEUTRACommand-r8 | MobilityFromEUTRACommand-r8-IEs, |
| mobilityFromEUTRACommand-r9 | MobilityFromEUTRACommand-r9-IEs, |

```
      mobilityFromEUTRACommand-r12 MobilityFromEUTRACommand-r12-IEs,
      spare1 NULL
    },
```

| | |
|---|---|
| criticalExtensionsFuture | SEQUENCE { } |
| } | |
| } | |

MobilityFromEUTRACommand-r8-IEs ::= SEQUENCE {

| | |
|---|---|
| cs-FallbackIndicator | BOOLEAN, |
| purpose | CHOICE{ |
| handover | Handover, |
| cellChangeOrder | CellChangeOrder |
| }, | |
| nonCriticalExtension | MobilityFromEUTRACommand-v8a0-IEs |
| OPTIONAL | |
| } | |

MobilityFromEUTRACommand-v8a0-IEs ::= SEQUENCE {

| | | |
|---|---|---|
| lateNonCriticalExtension | OCTET STRING | OPTIONAL, -- Need |
| OP | | |

| | | |
|---|---|---|
| nonCriticalExtension | MobilityFromEUTRACommand-v8d0-IEs | OPTIONAL |
| } | | |

MobilityFromEUTRACommand-v8d0-IEs ::= SEQUENCE {

| | | |
|---|---|---|
| bandIndicator | BandIndicatorGERAN | OPTIONAL, -- Cond |
| GERAN | | |
| nonCriticalExtension | SEQUENCE { } | OPTIONAL -- Need OP |
| } | | |

MobilityFromEUTRACommand-r9-IEs ::=SEQUENCE {

| | |
|---|---|
| cs-Fallbacklndicator | BOOLEAN, |
| purpose | CHOICE{ |
| handover | Handover, |
| cellChangeOrder | CellChangeOrder, |
| e-CSFB-r9 | E-CSFB-r9, |
| ... | |
| }, | |
| nonCriticalExtension | MobilityFromEUTRACommand-v930-IEs |
| OPTIONAL | |
| } | |

MobilityFromEUTRACommand-v930-IEs ::= SEQUENCE {

| | | |
|---|---|---|
| lateNonCriticalExtension | OCTET STRING | OPTIONAL, -- Need |
| OP | | |

| | | |
|---|---|---|
| nonCriticalExtension | MobilityFromEUTRACommand-v960-IEs | OPTIONAL |
| } | | |

MobilityFromEUTRACommand-v960-IEs ::= SEQUENCE {

| | | |
|---|---|---|
| bandIndicator | BandIndicatorGERAN | OPTIONAL, -- Cond |
| GERAN | | |
| nonCriticalExtension | SEQUENCE { } | OPTIONAL -- Need OP |
| } | | |

| | |
|---|---|
| Handover ::= | SEQUENCE { |

| targetRAT-Type | ENUMERATED { | |
|---|---|---|
| | utra, geran, cdma2000-1XRTT, cdma2000-HRPD, | |
| | spare4, spare3, spare2, spare1, ...}, | |
| targetRAT-MessageContainer | OCTET STRING, | |
| nas-SecurityParamFromEUTRA | OCTET STRING (SIZE (1)) | OPTIONAL, -- Cond |
| UTRAGERAN | | |

| | | |
|---|---|---|
| systemInformation | SI-OrPSI-GERAN | OPTIONAL -- Cond PSHO |
| } | | |

| | |
|---|---|
| CellChangeOrder ::= | SEQUENCE { |

| t304 | ENUMERATED { | |
|---|---|---|
| | ms100, ms200, ms500, ms1000, | |
| | ms2000, ms4000, ms8000, sparel}, | |
| targetRAT-Type | CHOICE { | |
| geran | SEQUENCE { | |
| physCellId | PhysCellIdGERAN, | |
| carrierFreq | CarrierFreqGERAN, | |
| networkControlOrder | BIT STRING (SIZE (2)) | OPTIONAL, - |
| - Need OP | | |

| | | |
|---|---|---|
| systemInformation | SI-OrPSI-GERAN | OPTIONAL -- Need |
| OP | | |
| }, | | |
| ... | | |
| } | | |
| } | | |
| SI-OrPSI-GERAN ::= | CHOICE { | |
| si | SystemInfoListGERAN, | |
| psi | SystemInfoListGERAN | |
| } | | |

| | |
|---|---|
| E-CSFB-r9 ::= | SEQUENCE { |

| | | |
|---|---|---|
| messageContCDMA2000-1XRTT-r9 | OCTET STRING | OPTIONAL, -- Need ON |
| mobilityCDMA2000-HRPD-r9 | ENUMERATED { | |
| | handover, redirection | |
| | } | OPTIONAL, -- Need OP |
| messageContCDMA2000-HRPD-r9 | OCTET STRING | OPTIONAL, -- Cond concHO |

| | | |
|---|---|---|
| redirectCarrierCDMA2000-HRPD-r9 | CarrierFreqCDMA2000 | OPTIONAL -- Cond concRedir |
| } | | |

MobilityFromEUTRACommand-r12-IEs ::= SEQUENCE {

| | | |
|---|---|---|
| Wlan-trigger | WLAN-Trigger | OPTIONAL, |

| | |
|---|---|
| nonCriticalExtension | MobilityFromEUTRACommand-v930-IEs |
| OPTIONAL | |
| } | |
| -- ASN1STOP | |

In another example, node 104 may transmit the non-cellular network access information IE as part of a DLInformationTransfer RRC message addressed to UE 102.

In another example, node 104 may transmit the WLAN trigger IE as part of a RRCConnectionReconfiguration message addressed to UE 102.

In another example, node 104 may transmit the WLAN trigger IE as part of a HandoverFromEUTRAPreparationRequest message addressed to UE 102.

In another example, node 104 may transmit the WLAN trigger IE as part of a DLInformationTransfer message addressed to UE 102.

In another example, node 104 may transmit the WLAN trigger IE as part of a RRCConnectionRelease message addressed to UE 102.

In some demonstrative embodiments, node 104 may transmit the WLAN trigger IE as part of any other RRC message addressed to UE 102.

In some demonstrative embodiments, node 104 may transmit the WLAN trigger IE as part of a dedicated RRC message defined for communicating the WLAN trigger.

In other embodiments, the RRC message may include the WLAN trigger in any other format.

In other embodiments, the WLAN trigger may be included as part of any other RRC signaling message or any other Information Element (IE).

In some demonstrative embodiments, the WLAN trigger IE may include one or more bits indicating one or more WLAN actions to be performed by UE 102.

In one example, the WLAN trigger IE may be communicated to trigger a WLAN action, and the WLAN trigger IE may include a single bit to indicate the WLAN action. For example, the bit may have a predefined value, e.g., “1”, to indicate that the WLAN action is for be performed.

In some demonstrative embodiments, the WLAN trigger IE may include additional information related to the WLAN action. For example, the WLAN trigger IE may include WLAN information relating to at least one WLAN.

In some demonstrative embodiments, node 104 may transmit to UE 102 a message including a WLAN mobility trigger IE to trigger UE 102 to connect to a WLAN, e.g., a WLAN managed by WLAN AP 161. For example, the WLAN trigger IE may include network access information corresponding to WLAN AP 161. The network access information may include any information, which may be used by UE 102, to discover, access and/or connect to WLAN AP 161.

In one example, the network access information corresponding to WLAN AP 161 may include an address of AP 161, a Service Set Identification (SSID) of AP 161, a Basic Service Set Identification (BSSID) of AP 161, a wireless communication frequency band for communicating with AP 161, a wireless communication frequency channel for communicating with AP 161, one or more attributes of a Physical Layer (PHY) of AP 161, security information corresponding to a secure WLAN connection, e.g., a WLAN security mode and/or WLAN security credentials, and/or any other information, e.g., as defined by the IEEE 802.11 and/or the WGA specifications and/or any other specification.

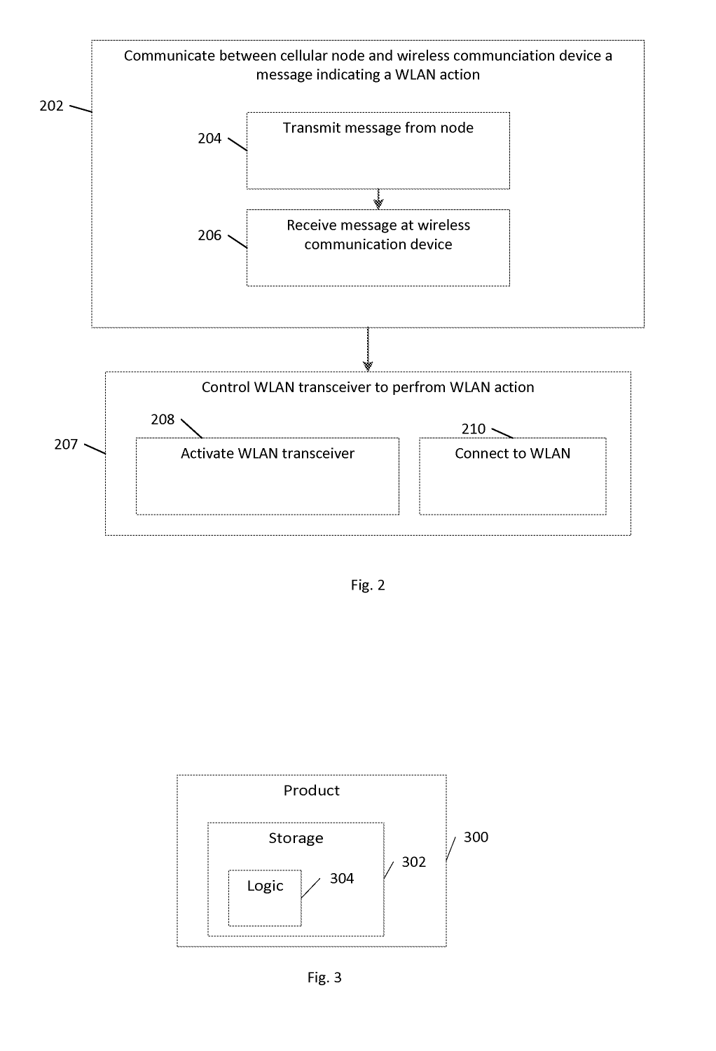

Reference is made to FIG. 2, which schematically illustrates a method of triggering a WLAN action of a wireless communication device, in accordance with some demonstrative embodiments. In some embodiments, one or more of the operations of the method of FIG. 2 may be performed by a wireless communication system e.g., system 100 (FIG. 1); a wireless communication device, e.g., UE 102 (FIG. 1), node 104 (FIG. 1) and/or AP 106 (FIG. 1); and/or a wireless communication unit, e.g., wireless communication units 110 and/or 130 (FIG. 1).

As indicated at block 202, the method may include communicating between a cellular node and a wireless communication device at least one message including an indication of at least one action to be performed by a WLAN transceiver of the wireless communication device. For example, node 104 (FIG. 1) may communicate with UE 102 (FIG. 1) a message including at least one WLAN trigger to trigger WLAN transceiver 163 to perform at least one WLAN action, e.g., as described above.

As indicated at block 204, communicating the message may include transmitting the message from the cellular node. For example, node 104 (FIG. 1) may transmit a message including the WLAN trigger, e.g., as described above.

As indicated at block 206, communicating the message may include receiving the message at the wireless communication device. For example, UE 102 (FIG. 1) may receive the message transmitted by node 104 (FIG. 1), e.g., as described above.

As indicated at block 207, the method may include controlling the WLAN transceiver to perform the WLAN action.

As indicated at block 208, the method may include activating the WLAN transceiver of the wireless communication device based on the message. For example, controller 145 (FIG. 1) may activate WLAN transceiver 163 (FIG. 1), for example, if the message includes a WLAN wakeup trigger, e.g., as described above.

As indicated at block 210, the method may include connecting the wireless communication device to a WLAN based on the message. For example, controller 145 (FIG. 1) may control WLAN transceiver 163 (FIG. 1) to connect to WLAN AP 161, for example, if the message includes a WLAN mobility trigger, e.g., as described above.

Reference is made to FIG. 3, which schematically illustrates a product of manufacture 300, in accordance with some demonstrative embodiments. Product 300 may include a non-transitory machine-readable storage medium 302 to store logic 304, which may be used, for example, to perform at least part of the functionality of UE 102 (FIG. 1), node 104 (FIG. 1), AP 106 (FIG. 1), wireless communication unit 110 (FIG. 1), wireless communication unit 130 (FIG. 1) and/or to perform one or more operations of the method of FIG. 2. The phrase “non-transitory machine-readable medium” is directed to include all computer-readable media, with the sole exception being a transitory propagating signal.

In some demonstrative embodiments, product 300 and/or machine-readable storage medium 302 may include one or more types of computer-readable storage media capable of storing data, including volatile memory, non-volatile memory, removable or non-removable memory, erasable or non-erasable memory, writeable or re-writeable memory, and the like. For example, machine-readable storage medium 302 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 304 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 304 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

Example 1 includes an Evolved Node B (eNB) comprising two or more antennas; and a radio to transmit a control message to a User Equipment (UE), the control message including a Wireless Local Area Network (WLAN) trigger to trigger one or more actions by a WLAN transceiver of the UE.

Example 2 includes the subject matter of Example 1 and optionally, wherein the trigger comprises WLAN wakeup trigger to trigger the UE to activate the WLAN transceiver.

Example 3 includes the subject matter of Example 1 or 2 and optionally, wherein the WLAN trigger comprises a WLAN mobility trigger to trigger the WLAN transceiver to connect to a WLAN.

Example 4 includes the subject matter of Example 3 and optionally, wherein the WLAN trigger is to trigger the WLAN transceiver to perform at least one operation selected from the group consisting of WLAN association, WLAN scanning, and WLAN access network discovery via an Access Network Discovery and Selection Function (ANDSF).

Example 5 includes the subject matter of any one of Examples 1-4 and optionally, wherein the eNB is to transmit the control message to the UE based on a location of the UE relative to a coverage area of a WLAN.

Example 6 includes the subject matter of any one of Examples 1-5 and optionally, wherein the control message comprises a System Information Block (SIB).

Example 7 includes the subject matter of any one of Examples 1-5 and optionally, wherein the control message comprises a Radio-Resource Control (RRC) signaling message.

Example 8 includes the subject matter of Example 7 and optionally, wherein the RRC signaling message comprises a MobilityFromEUTRACommand, a RRCConnectionRelease or a dedicated RRC message.

Example 9 includes the subject matter of any one of Examples 1-8 and optionally, comprising a WLAN Access Point (AP), the WLAN trigger is to trigger the UE to connect to the WLAN AP.

Example 10 includes a User Equipment (UE) comprising a Wireless Local Area Network (WLAN) transceiver; a cellular transceiver to communicate with an Evolved Node B (eNB) over a cellular link and to receive from the eNB an information element (IE) indicating at least one WLAN action; and a controller to control the WLAN transceiver to perform the action.

Example 11 includes the subject matter of Example 10 and optionally, wherein the IE includes a WLAN wakeup trigger, and wherein the controller is to activate the WLAN transceiver.

Example 12 includes the subject matter of Example 10 or 11 and optionally, wherein the IE comprises a WLAN mobility trigger, and wherein the controller is to control the WLAN transceiver to connect to a WLAN.

Example 13 includes the subject matter of Example 12 and optionally, wherein the cellular transceiver is to receive the IE when the UE is within a coverage area of the WLAN.

Example 14 includes the subject matter of Example 12 or 13 and optionally, wherein the controller is to control the WLAN transceiver to perform at least one operation selected from the group consisting of WLAN association, WLAN scanning, and WLAN access network discovery via an Access Network Discovery and Selection Function (ANDSF).

Example 15 includes the subject matter of any one of Examples 10-14 and optionally, wherein the cellular transceiver is to receive a System Information Block (SIB) including the IE.

Example 16 includes the subject matter of any one of Examples 10-14 and optionally, wherein a Radio-Resource Control (RRC) signaling message carries the IE.

Example 17 includes the subject matter of Example 16 and optionally, wherein the RRC signaling message comprises a MobilityFromEUTRACommand, a RRCConnectionRelease or a dedicated RRC message.

Example 18 includes the subject matter of any one of Examples 10-17 and optionally, wherein the cellular transceiver is to receive the IE from an eNB comprising a WLAN Access Point (AP), and wherein the controller is to control the WLAN transceiver to connect to the WLAN AP.

Example 19 includes a method comprising communicating between an Evolved Node B (eNB) and a User Equipment (UE) at least one message including an indication of at least one action to be performed by a WLAN transceiver of the UE.

Example 20 includes the subject matter of Example 19 and optionally, comprising receiving the message at the UE.

Example 21 includes the subject matter of Example 20 and optionally, comprising activating the WLAN transceiver based on the message.

Example 22 includes the subject matter of Example 20 and optionally, comprising connecting to a WLAN based on the message.

Example 23 includes the subject matter of Example 22 and optionally, wherein receiving the message comprises receiving the message when the UE is within a coverage area of the WLAN.

Example 24 includes the subject matter of any one of Examples 20-23 and optionally, comprising performing at least one operation selected from the group consisting of WLAN association, WLAN scanning, and WLAN access network discovery via an Access Network Discovery and Selection Function (ANDSF).

Example 25 includes the subject matter of Example 19 and optionally, comprising transmitting the message from the eNB.

Example 26 includes the subject matter of Example 25 and optionally, wherein the eNB comprises a WLAN Access Point (AP), and wherein the message is to trigger the UE to connect to the WLAN AP.

Example 27 includes the subject matter of Example 25 or 26 and optionally, wherein transmitting the message comprises transmitting the message based on a location of the UE relative to a coverage area of a WLAN.

Example 28 includes the subject matter of any one of Examples 19-27 and optionally, wherein the message comprises a WLAN trigger Information Element (IE) to trigger the action.

Example 29 includes the subject matter of any one of Examples 19-28 and optionally, wherein the message comprises a System Information Block (SIB).

Example 30 includes the subject matter of any one of Examples 19-28 and optionally, wherein the message comprises a Radio-Resource Control (RRC) signaling message.

Example 31 includes the subject matter of Example 30 and optionally, wherein the RRC signaling message comprises a MobilityFromEUTRACommand, a RRCConnectionRelease or a dedicated RRC message.

Example 32 includes a product including a non-transitory storage medium having stored thereon instructions that, when executed by a machine, result in communicating between an Evolved Node B (eNB) and a User Equipment (UE) at least one message including an indication of at least one action to be performed by a WLAN transceiver of the UE.

Example 33 includes the subject matter of Example 32 and optionally, wherein the instructions result in receiving the message at the UE.

Example 34 includes the subject matter of Example 33 and optionally, wherein the instructions result in activating the WLAN transceiver based on the message.

Example 35 includes the subject matter of Example 33 and optionally, wherein the instructions result in connecting to a WLAN based on the message.

Example 36 includes the subject matter of Example 35 and optionally, wherein receiving the message comprises receiving the message when the UE is within a coverage area of the WLAN.

Example 37 includes the subject matter of any one of Examples 33-36 and optionally, wherein the instructions result in performing at least one operation selected from the group consisting of WLAN association, WLAN scanning, and WLAN access network discovery via an Access Network Discovery and Selection Function (ANDSF).

Example 38 includes the subject matter of Example 32 and optionally, wherein the instructions result in transmitting the message from the eNB.

Example 39 includes the subject matter of Example 38 and optionally, wherein the eNB comprises a WLAN Access Point (AP), and wherein the message is to trigger the UE to connect to the WLAN AP.

Example 40 includes the subject matter of Example 38 or 39 and optionally, wherein transmitting the message comprises transmitting the message based on a location of the UE relative to a coverage area of a WLAN.

Example 41 includes the subject matter of any one of Examples 32-40 and optionally, wherein the message comprises a WLAN trigger Information Element (IE) to trigger the action.

Example 42 includes the subject matter of any one of Examples 32-41 and optionally, wherein the message comprises a System Information Block (SIB).

Example 43 includes the subject matter of any one of Examples 32-41 and optionally, wherein the message comprises a Radio-Resource Control (RRC) signaling message.

Example 44 includes the subject matter of Example 43 and optionally, wherein the RRC signaling message comprises a MobilityFromEUTRACommand, a RRCConnectionRelease or a dedicated RRC message.

Example 45 includes an apparatus comprising means for communicating between an Evolved Node B (eNB) and a User Equipment (UE) at least one message including an indication of at least one action to be performed by a WLAN transceiver of the UE.

Example 46 includes the subject matter of Example 45 and optionally, comprising means for receiving the message at the UE.

Example 47 includes the subject matter of Example 46 and optionally, comprising means for activating the WLAN transceiver based on the message.

Example 48 includes the subject matter of Example 46 and optionally, comprising means for connecting to a WLAN based on the message.

Example 49 includes the subject matter of Example 48 and optionally, wherein receiving the message comprises receiving the message when the UE is within a coverage area of the WLAN.

Example 50 includes the subject matter of any one of Examples 46-49 and optionally, comprising means for performing at least one operation selected from the group consisting of WLAN association, WLAN scanning, and WLAN access network discovery via an Access Network Discovery and Selection Function (ANDSF).

Example 51 includes the subject matter of Example 45 and optionally, comprising means for transmitting the message from the eNB.

Example 52 includes the subject matter of Example 50 and optionally, wherein the eNB comprises a WLAN Access Point (AP), and wherein the message is to trigger the UE to connect to the WLAN AP.

Example 53 includes the subject matter of Example 50 or 51 and optionally, wherein transmitting the message comprises transmitting the message based on a location of the UE relative to a coverage area of a WLAN.

Example 54 includes the subject matter of any one of Examples 45-53 and optionally, wherein the message comprises a WLAN trigger Information Element (IE) to trigger the action.

Example 55 includes the subject matter of any one of Examples 45-54 and optionally, wherein the message comprises a System Information Block (SIB).

Example 56 includes the subject matter of any one of Examples 45-54 and optionally, wherein the message comprises a Radio-Resource Control (RRC) signaling message.

Example 57 includes the subject matter of Example 56 and optionally, wherein the RRC signaling message comprises a MobilityFromEUTRACommand, a RRCConnectionRelease or a dedicated RRC message.

Example 58 includes a cellular node comprising one or more antennas; and a radio to transmit a control message to a wireless communication device over a cellular link, the control message including a Wireless Local Area Network (WLAN) trigger to trigger one or more actions by a WLAN transceiver of the wireless communication device.

Example 59 includes the subject matter of Example 58 and optionally, wherein the trigger comprises WLAN wakeup trigger to trigger the wireless communication device to activate the WLAN transceiver.

Example 60 includes the subject matter of Example 58 or 59 and optionally, wherein the WLAN trigger comprises a WLAN mobility trigger to trigger the WLAN transceiver to connect to a WLAN.

Example 61 includes the subject matter of Example 60 and optionally, wherein the WLAN trigger is to trigger the WLAN transceiver to perform at least one operation selected from the group consisting of WLAN association, WLAN scanning, and WLAN access network discovery via an Access Network Discovery and Selection Function (ANDSF).

Example 62 includes the subject matter of any one of Examples 58-61 and optionally, wherein the cellular node is to transmit the control message to the wireless communication device based on a location of the wireless communication device relative to a coverage area of a WLAN.

Example 63 includes the subject matter of any one of Examples 58-62 and optionally, wherein the control message comprises a System Information Block (SIB).

Example 64 includes the subject matter of any one of Examples 58-62 and optionally, wherein the control message comprises a Radio-Resource Control (RRC) signaling message.

Example 65 includes the subject matter of Example 64 and optionally, wherein the RRC signaling message comprises a MobilityFromEUTRACommand, a RRCConnectionRelease or a dedicated RRC message.

Example 66 includes the subject matter of any one of Examples 58-65 and optionally, comprising a WLAN Access Point (AP), the WLAN trigger is to trigger the wireless communication device to connect to the WLAN AP.

Example 67 includes a wireless communication device comprising a Wireless Local Area Network (WLAN) transceiver; a cellular transceiver to communicate with a cellular node over a cellular link and to receive from the cellular node an information element (IE) indicating at least one WLAN action; and a controller to control the WLAN transceiver to perform the action.

Example 68 includes the subject matter of Example 67 and optionally, wherein the IE includes a WLAN wakeup trigger, and wherein the controller is to activate the WLAN transceiver.

Example 69 includes the subject matter of Example 67 or 68 and optionally, wherein the IE comprises a WLAN mobility trigger, and wherein the controller is to control the WLAN transceiver to connect to a WLAN.

Example 70 includes the subject matter of Example 69 and optionally, wherein the cellular transceiver is to receive the IE when the wireless communication device is within a coverage area of the WLAN.

Example 71 includes the subject matter of Example 69 or 70 and optionally, wherein the controller is to control the WLAN transceiver to perform at least one operation selected from the group consisting of WLAN association, WLAN scanning, and WLAN access network discovery via an Access Network Discovery and Selection Function (ANDSF).

Example 72 includes the subject matter of any one of Examples 67-71 and optionally, wherein the cellular transceiver is to receive a System Information Block (SIB) including the IE.

Example 73 includes the subject matter of any one of Examples 67-71 and optionally, wherein a Radio-Resource Control (RRC) signaling message carries the IE.

Example 74 includes the subject matter of Example 73 and optionally, wherein the RRC signaling message comprises a MobilityFromEUTRACommand, a RRCConnectionRelease or a dedicated RRC message.

Example 75 includes the subject matter of any one of Examples 67-74 and optionally, wherein the cellular transceiver is to receive the IE from a cellular node comprising a WLAN Access Point (AP), and wherein the controller is to control the WLAN transceiver to connect to the WLAN AP.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

1-25. (canceled)

26. An Evolved Node B (eNB) comprising:
two or more antennas; and
a radio to transmit a control message to a User Equipment (UE), the control message including a Wireless Local Area Network (WLAN) trigger to trigger one or more actions by a WLAN transceiver of said UE.

27. The eNB of claim 26, wherein said trigger comprises WLAN wakeup trigger to trigger said UE to activate said WLAN transceiver.

28. The eNB of claim 26, wherein said WLAN trigger comprises a WLAN mobility trigger to trigger said WLAN transceiver to connect to a WLAN.

29. The eNB of claim 28, wherein said WLAN trigger is to trigger said WLAN transceiver to perform at least one operation selected from the group consisting of WLAN association, WLAN scanning, and WLAN access network discovery via an Access Network Discovery and Selection Function (ANDSF).

30. The eNB of claim 26, wherein said eNB is to transmit said control message to said UE based on a location of said UE relative to a coverage area of a WLAN.

31. The eNB of claim 26, wherein said control message comprises a System Information Block (SIB).

32. The eNB of claim 26, wherein said control message comprises a Radio-Resource Control (RRC) signaling message.

33. The eNB of claim 32, wherein said RRC signaling message comprises a MobilityFromEUTRACommand, a RRCConnectionRelease or a dedicated RRC message.

34. The eNB of claim 26 comprising a WLAN Access Point (AP), said WLAN trigger is to trigger said UE to connect to said WLAN AP.

35. A User Equipment (UE) comprising:
a Wireless Local Area Network (WLAN) transceiver;
a cellular transceiver to communicate with an Evolved Node B (eNB) over a cellular link and to receive from said eNB an information element (IE) indicating at least one WLAN action; and
a controller to control said WLAN transceiver to perform said action.

36. The UE of claim 35, wherein said IE includes a WLAN wakeup trigger, and wherein said controller is to activate said WLAN transceiver.

37. The UE of claim 35, wherein said IE comprises a WLAN mobility trigger, and wherein said controller is to control said WLAN transceiver to connect to a WLAN.

38. The UE of claim 37, wherein said controller is to control said WLAN transceiver to perform at least one operation selected from the group consisting of WLAN association, WLAN scanning, and WLAN access network discovery via an Access Network Discovery and Selection Function (ANDSF).

39. The UE of claim 35, wherein said cellular transceiver is to receive a System Information Block (SIB) including said IE.

40. The UE of claim 35, wherein a Radio-Resource Control (RRC) signaling message carries said IE.

41. The UE of claim 40, wherein said RRC signaling message comprises a MobilityFromEUTRACommand, a RRCConnectionRelease or a dedicated RRC message.

42. The UE of claim 35, wherein said cellular transceiver is to receive said IE from an eNB comprising a WLAN Access Point (AP), and wherein said controller is to control said WLAN transceiver to connect to said WLAN AP.

43. A method comprising:
communicating between an Evolved Node B (eNB) and a User Equipment (UE) at least one message including an indication of at least one action to be performed by a WLAN transceiver of said UE.

44. The method of claim 43 comprising receiving said message at said UE.

45. The method of claim 44 comprising activating said WLAN transceiver based on said message.

46. The method of claim 44 comprising connecting to a WLAN based on said message.

47. The method of claim 44 comprising performing at least one operation selected from the group consisting of WLAN association, WLAN scanning, and WLAN access network discovery via an Access Network Discovery and Selection Function (ANDSF).

48. The method of claim 43 comprising transmitting said message from said eNB.

49. A product including a non-transitory storage medium having stored thereon instructions that, when executed by a machine, result in:
communicating between an Evolved Node B (eNB) and a User Equipment (UE) at least one message including an indication of at least one action to be performed by a WLAN transceiver of said UE.

50. The product of claim 49, wherein the instructions result in receiving said message at said UE.

51. The product of claim 50, wherein the instructions result in activating said WLAN transceiver based on said message.

52. The product of claim 50, wherein the instructions result in connecting to a WLAN based on said message.

53. The product of claim 50, wherein the instructions result in performing at least one operation selected from the group consisting of WLAN association, WLAN scanning, and WLAN access network discovery via an Access Network Discovery and Selection Function (ANDSF).

54. The product of claim 49, wherein the instructions result in transmitting said message from said eNB.

55. The product of claim 49, wherein said message comprises a Radio-Resource Control (RRC) signaling message.
